(19) United States
(12) Patent Application Publication
(10) Pub. No.: US 2017/0015792 A1
(43) Pub. Date: Jan. 19, 2017

(54) METHOD FOR EFFICIENT EXTRACTION OF LIGNIN

(71) Applicant: REN FUEL K2B AB, Stockholm (SE)

(72) Inventors: Joseph SAMEC, Spanga (SE); Joakim LOFSTEDT, Uppsala (SE); Christian DAHLSTRAND, Uppsala (SE); Alexander OREBOM, Uppsala (SE); Supapom SAWADJOON, Uppsala (SE)

(73) Assignee: REN FUEL K2B AB, Stockholm (SE)

(21) Appl. No.: 15/124,782

(22) PCT Filed: Mar. 11, 2015
(86) PCT No.: PCT/SE2015/050270

§ 371 Date: Sep. 9, 2016

(30) Foreign Application Priority Data
Mar. 12, 2014 (SE) 1450281-9

(51) Int. Cl. C08H 7/00; C07G 1/00

(52) U.S. Cl. CPC C08H 6/00; C07G 1/00

(57) ABSTRACT

A method of extracting lignin from an aqueous composition by either treating the composition with a solvent and heat, or by acidifying the composition in order to induce phase separation.

### FIELD OF THE INVENTION

The present invention provides a method and system for extracting and treating lignin in an efficient manner in order to obtain lignin derivatives which may be processed into fuels or fine chemicals.

### BACKGROUND

Lignin is a complex biopolymer found in the cell walls of plants and is most commonly derived from wood and some algae. Lignin, cellulose, hemicellulose and pectin are the major components in the cell wall and lignin, together with the hemicellulose, provide mechanical strength to the cell wall.

Today lignin may be used as a component in for example pellet fuel as a binder but it may also be used as an energy source due to its high energy content. Lignin has higher energy content than cellulose or hemicelluloses and one gram of lignin has on average 2.27 KJ, which is 30% more than the energy content of cellulosic carbohydrate. The energy content of lignin is similar to that of coal. Today, due to its fuel value lignin removed using the kraft process, sulphate process, in a pulp or paper mill, is usually burned. in order to provide energy to run the production process and to recover the chemicals from the cooking liquor.

Biofuel, such as biogasoline and biodiesel, is a fuel in which the energy is mainly derived from biomass material or gases such as wood, corn, sugarcane, animal fat, vegetable oils and so on. However the biofuel industries are struggling with issues like food vs fuel debate, efficiency and the general supply of raw material. At the same time the pulp or paper making industries produces huge amounts of lignin which is often, as described above, only burned in the mill.

Two common strategies for exploring biomass as a fuel or fuel component are to use pyrolysis oils or hydrogenated lignin. However these strategies demand high pressure and the use of hydrogen gas which is both expensive and may be dangerous. There is therefore a need for a less complex method to prepare biomass in order for it to be processed at a biorefinery, but also in order to process the lignin into fine chemicals or paint or paint additives for example.

Still there is a problem of extracting lignin from aqueous solutions into a suitable solvent in order to treat the lignin.

### SUMMARY OF THE INVENTION

The aim of the present invention is to provide a method for obtaining lignin in an organic solvent and to solve the problems of the prior art.

In a first aspect the present invention relates to a method as defined in claim 1.

In a second aspect the present invention relates to lignin derivatives obtainable by the method according to the present invention.

In a third aspect the present invention relates to a method of treating lignin comprising:
a. Providing a feed of lignin into a first container;
b. Adding a solvent to the container forming a first mixture of lignin and solvent and heating the mixture until a sufficient amount of lignin is extracted into the solvent forming a first solution;
c. Isolating the first solution from the first mixture leaving a second mixture; and
d. Treating the lignin of the isolated first solution by reduction or functionalization.

### BRIEF DESCRIPTION OF THE FIGURES

FIG. 1 shows a schematic view of the system for reduction according to the present invention.

FIG. 2 shows a schematic view of the system for reduction according to the present invention.

FIG. 3 shows GPC data from extracted lignin and extracted lignin that has been reduced.

FIG. 4 shows a HSQC NMR from extracted lignin that has been reduced.

FIG. 5 show a HMBC NMR from extracted lignin that has been reduced.

FIG. 6 shows the effect of the different solvents on the extraction yields (from dry solid) of lignin. Grey is the yield of the solvent extraction which was repeated three times. Black is the yield of the first extraction.

FIG. 7 shows the effect of the different solvents on the extraction yields (from dry solid) of Black liquor. White is the yield of the solvent extraction which was repeated three times. Black is the yield of the first extraction.

FIG. 8 shows the effect of the different solvents on the phase extraction of Black liquor. The black phase on the top is the organic phase and the phase at the bottom is the aqueous phase.

### DETAILED DESCRIPTION OF THE INVENTION

In the present application the term “lignin” means a polymer comprising coumaryl alcohol, coniferyl alcohol and sinapyl alcohol monomers.

In the present application the term “lignin derivative” means molecules or polymers derived from lignin. In the present application “lignin derivative” and “molecules or polymers derived from lignin” are used interchangeably. These molecules or polymers may be a result of chemical modification or degradation of lignin or a lignin source, for example when treating black or red liquor in order to precipitate or separate lignin.

In the present application the term “lignin derivative” means molecules or polymers derived from lignin. In the present application “lignin derivative” and “molecules or polymers derived from lignin” are used interchangeably. These molecules or polymers may be a result of chemical modification or degradation of lignin or a lignin source, for example when treating black or red liquor in order to precipitate or separate lignin. The number average molecular weight (Mₙ) of the lignin derivative may be 500 g/mol or higher, or 800 g/mol or higher, for example 500-2000 g/mol, or 700-1500 g/mol.

One problem when treating or functionalizing lignin is that lignin is not soluble in organic solvents which limits the number of available treatments. Another problem when treating lignin is the broad distribution of the molecular weight which affects the efficiency of the treatment. One way of solving the problem is to add more reactants or more catalyst to the reaction however that strategy increases the cost but also results in less control of the reaction and more problematic isolation of the various products and reactants.

For a substance to be processed in a refinery such as an oil refinery or bio oil refinery, the substance needs to be in liquid phase. Either the substance is in liquid phase at a given temperature (usually below 80° C.) or the substance is dissolved in a liquid. Preferably the liquid, often called “carrier liquid”, is an oil such as gas oil. Since lignin is water soluble it needs to be treated in order to be at least partly soluble in an oil or other non-polar solvents. The present invention aims at providing lignin or lignin derivatives which are or may be further treated to be at least partly soluble in an oil or non-polar solvents. The further treatment of the lignin or lignin derivatives is reduction or esterification.

The present invention relates to a method of treating lignin where a fraction of the lignin is extracted prior to the treatment. The extraction step reduces the amount of catalyst needed and the treatment needs less harsh conditions (lower temperature and pressure). Depending on the solvent used any hemi cellulose or other contaminants may be separated from the lignin increasing the pureness of the product and limits the risk of poisoning of the catalysts. It is further believed that the obtained treated lignin is more suitable for further refinements for example in a refinery. The extraction facilitates higher lignin concentrations in the treatment step and also facilitates a continuous treatment process as the degree of fouling would be decreased. In comparison with other separation processes, filtration for example, the extraction process is simpler and cheaper.

The system for Treating Lignin

The present system may be used for both extracting method described herein. In other words the system may be adapted to fit the extraction using acidification and the disclosure of the system is not limited to only the use of only a solvent and heating. For example the means for providing solvent may also be means for providing an acid in order to lower the pH.

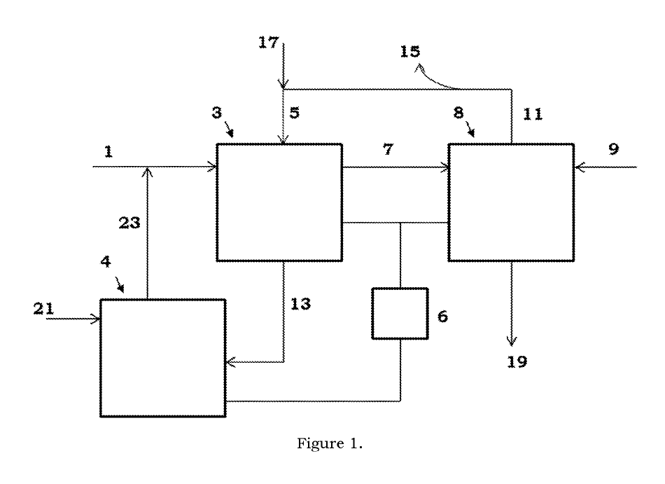

Referring now to FIG. 1, the system for treating or extracting lignin according to the method of claim 1 comprises means (1) for providing the feed of lignin into the first container (3) and means (5) for providing the solvent to the first container (3). The system further comprises a heating device (6) for heating the first mixture during extraction and the first solution during reduction and means (7 or 13) for isolating the first solution comprising extracted lignin and the solvent from the first mixture leaving a second mixture. The means (7) and (13) may be comprise a tap or faucet connected to a tubing or it may comprise means for suction or pumping the remaining mixture. The system may further comprise a second container (4) which in turn is connected to the means (1) providing the feed. In this way the high molecular weight lignin that is not extracted may be circulated between the first (3) and the second container (4). To the first and second container may a catalyst and/or a reagent be added through the means (5) and (21) respectively. Solvent may also be added using means (5) and (21) respectively. The means (1) and (5) may be suitable tubing and a pump. All the containers may contain suitable means for mixing the content of the containers. The means for mixing may for example be stirrers or shakers.

The first solution may be isolated using means (7) and preferably fed into a third container (8). Additional solvent and catalyst may be added to the first solution using means (9). In order to reuse the solvent for extraction means (11) for returning the solvent back to the first container (3) may be arranged and said means (11) may be a pump and suitable tubing. Preferably the solvent is purified prior to addition to the first mixture for example volatile solvents that may be formed during the reduction of the first solution such as acetone may be removed (15). The means (7) may be suitable tubing and a pump or means for decantation.

When using the system for an acidified composition the second container may be used for an additional extraction step as described below where the isolated lignin is re-dissolved. The organic solvent phase may be discharged into the second container (4) and the aqueous solution may be discharged from the first container using any suitable means (for example means (7)) into the third container (8) and discharged using means (19). The organic solvent phase may then be added to the first container and the organic solvent is then removed via means means (7) and discharged via means (19) and an additional organic solvent is added via means (5) to the lignin in the first container (3). The organic solvent phase containing lignin is then isolated from any precipitated or non-dissolved substances by discharging said phase into the third container (8) via means (7) where the lignin may be further treated.

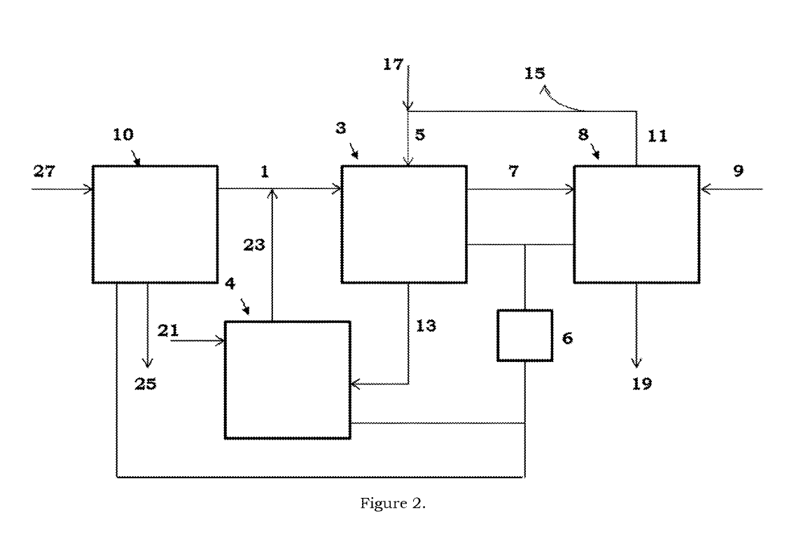

Referring now to FIG. 2. The system may further comprise additional containers (10) arranged prior to the first container (3). The feed of lignin is provided to the additional container (10) via means (27) (pump and tubing for example). A pre-solution is isolated using means (1) and transferred to the first container (3) while the second mixture in the additional container (10) is discharged using means (25). The extracted lignin in the first container (3) is isolated using means (7) and remaining mixture may be discharged using means (13). Said mixture may be further treated and optionally recirculated via means (23) and means (27) as will be further explained below. The first container (3) and the additional container (10) may be the same container. In one embodiment the first container (3) and the third container (8) are the same. The means (7) and (13) may be comprise a tap or faucet connected to a tubing or it may comprise means for suction or pumping the remaining mixture or the solution.

The treated lignin from the first solution may be discharged using means (19). In one embodiment the catalyst is removed from the treated lignin using any suitable means prior to discharging. The removed catalyst may then be reused, optionally after further purification and activation. The means (19) may be comprise a tap or faucet or it may comprise means for suction or pumping the treated lignin.

In one embodiment any catalyst used in the system is fixed on a catalyst bed and remains in the container after isolation or discharge.

The Method

In one aspect the method according to the present invention comprises:
a. Providing a feed of lignin into a first container;
b. Adding a solvent to the container forming a first mixture of lignin and solvent and heating the mixture until a sufficient amount of lignin is extracted into the solvent forming a first solution;
c. Isolating the first solution from the first mixture leaving a second mixture; and
d. Treating the lignin of the isolated first solution by reduction or functionalization.

This method may be used to obtain a less polydisperse lignin composition (i.e. a composition with a more narrow molecular weight distribution) or for isolating a certain range of molecular weight of lignin. By heating lignin in a suitable solvent the lignin of low molecular weight may stay in the solvent and then may be isolated. The method may also be used to remove hemi cellulose.

In another aspect the method relates to transferring lignin into an organic solvent comprising:
a. Providing an aqueous composition of lignin in a container;
b. Lowering the pH of the aqueous composition to a pH of 3 or less and mixing the composition;
c. Adding an organic solvent at least partly not soluble in water to the container forming a first mixture of lignin and organic solvent and mixing the first mixture;
d. Letting the first mixture phase separate into an organic solvent phase and an aqueous phase; and
e. Isolating the organic solvent phase from the first mixture.

By using an acidified solution or composition the yield of extracted lignin is increased and the phase separation makes the isolation step easier. Hemi cellulose may also be removed using this method. The method facilitates also a less polydisperse lignin composition since not all lignin will be extracted. The order of step b and c above may be altered, i.e. the addition of the organic solvent may be added prior to lowering of the pH.

The Extraction

The method, or process, may be a batch wise process where a first feed of lignin is added to the container and mixed with an acid and/or the solvent and optionally heating the formed mixture (the first mixture). The feed of lignin may be a dry lignin, semi dry or a solution of lignin for example black liquor. The mixture could be heated to 50° C. or higher, or 70° C. or higher, or 100° C. or higher. In one embodiment the mixture is heated to the boiling point of the added solvent or solvent mixture in the first mixture. The lignin parts of low molecular weight will be dissolved in the solvent. The dissolved lignin may then be removed. Which molecular weight that will be dissolved depends on the solvent. The first mixture could be stirred or shaken during the heating in order to extract the maximal amount of lignin. In one embodiment a continuous extraction is used to extract a maximum amount of lignin.

Preferred solvents are C1-C10 alcohols, C1-C10 ethers, and C1-C10 esters, for example methanol, ethanol, propanol, isopropanol, glycerol, sec-butanol and butyl ether such as tert-butyl methyl ether; diethyl ether, diglyme, diisopropyl ether, dimethoxyethane, diethylene glycol diethyl ether, polyethylene glycol 1,4-dioxane and tetrahydrofuran, methylated tetrahydrofuran. Preferred C1-C10 esters are organic esters, aromatic or non-aromatic esters, examples of esters are benzyl benzoate, various acetates such as methyl acetate, ethyl acetate, cyclopentyl methyl ether and butyl acetate, various lactates such as ethyl lactates. In one embodiment the solvent comprises a combination of C1-C10 alcohols, C1-C10 ethers and C1-C10 esters. In one embodiment the solvent is a C1-C4 alcohol. In one embodiment the solvent comprises two C1-C10 alcohols for example ethanol and glycerol, and in another embodiment the solvent comprises propanol and glycerol. In one embodiment the solvent comprises polyethylene glycol and a C1-C10 alcohol. In one embodiment the solvent is a cyclic ether such as tetrahydrofuran (THF) or substituted THF such as 2-Methyltetrahydrofuran. In one embodiment the solvent comprises furfural or furfuryl alcohol. In one embodiment the solvent is ethanol or iso-propanol, preferably iso-propanol. In one embodiment the solvent is methyl acetate or ethyl acetate. In another embodiment the solvent is a ketone such as butanone or methyl isobutyl ketone (MIBK). In one embodiment the solvent is a cyclic ether or C1-C10 ester such as methyl acetate or ethyl acetate or a ketone such as MIBK (methyl isobutyl ketone) or any combination thereof. When the solvent is a mixture of an organic solvent and water the mixture may contain methanol and water, ethanol and water, isopropanol and water or ethyl acetate and water, preferably ethanol and water, isopropanol and water and ethyl acetate and water. When the feed of lignin is black liquor at least one of the solvents added should not be completely water soluble.

The lignin may be extracted two or more times. For example by using THF or any other suitable solvent hemi cellulose may be removed very efficiently from the mixture. In one embodiment the method comprises an additional extraction step comprising adding a solvent to the feed of lignin which dissolves lignin but does not dissolve hemi cellulose, heating the formed mixture, extracting the lignin, isolating the extracted lignin and providing the extracted lignin to the first container, preferably the solvent is tetrahydrofuran (THF). A second solvent is then added to the lignin solution and heated extracting the low molecular weight lignin and isolating said low molecular weight lignin. The remaining high molecular weight lignin may be treated as described above when discharged into the second container (4). In one embodiment the second solvent is added to the second mixture and optionally also a transition metal catalyst.

In one embodiment a base is added to the first and/or the second mixture and/or the first solution for example ammonia or ammonium formate.

When extracting lignin from an acidified solution, i.e. a solution of lignin having a pH of 3 or less, an organic solvent is added to the acidified lignin solution. The organic solvent should not be completely soluble in water, or at least phase separate from the acidified aqueous solution, in order to extract the lignin. In one embodiment the organic solvent is a cyclic ether such as tetrahydrofuran (THF). In another embodiment the organic solvent is a substituted cyclic ether such as substituted THF such as 2-methyltetrahydrofuran. In another embodiment the solvent is a ketone such as butanone or methyl isobutyl ketone (MIBK). In one embodiment the solvent is a mixture of methyl acetate and THF or substituted THF, or a mixture of ethyl acetate and THF or substituted THF, or a mixture of MIBK and THF or substituted THF. The weight ratio may be from 10:1 to 0.1:1 (organic solvent:cyclic ether) such as 5:1 to 1:1. In one embodiment the solvent mixture is methyl acetate or ethyl acetate and THF in a 1:1 to 4:1 weight ratio. The choice of solvent or solvent mixture may influence the polydispersity of the extracted lignin and also what other substances will be extracted.

When lignin is extracted using acidification pH may be lowered using any suitable acid. A non-limiting list is hydrochloric acid, sulfuric acid, nitric acid, fluorosulfuric acid, phosphoric acid, fluoroboric acid or boric acid. In one embodiment the acid is hydrochloric acid or sulfuric acid. The pH should be approximately 3 or less, for example 2 or less. It is believed that the lower pH results both in a more pronounced phase separation and a higher yield of transferred lignin.

When lowering the pH the lignin may precipitate but the precipitate is then dissolved in the organic solvent added. When black liquor is used the solution (liquor) may be diluted with water for example by 10 wt % or more, or by 50 wt % or more, or by 100 wt % or more. The addition of the acid may be done after addition of the organic solvent, preferably during stirring.

After addition of the organic solvent to the acidified solution the formed mixture is preferably mixed (shaken or stirred for example) and then left to phase separate. The lignin will then be phase transferred from the aqueous phase to the organic phase.

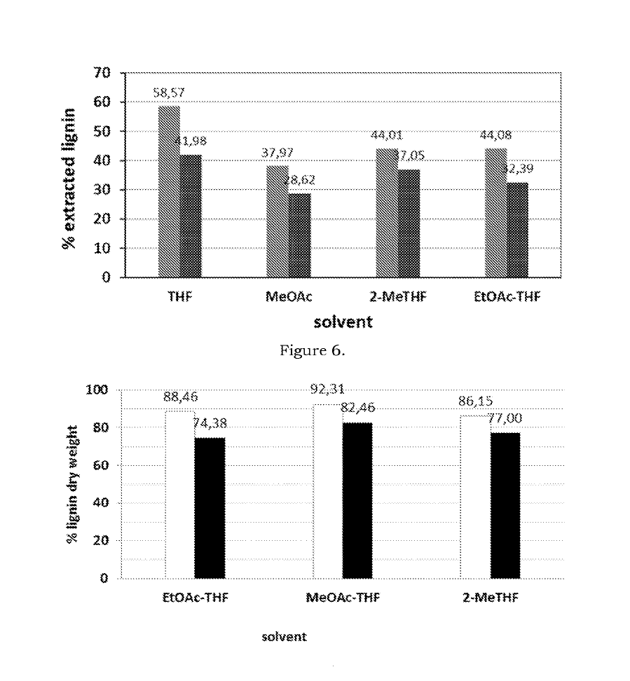

The organic phase may then be isolated using any suitable way (decantation or pumping for example). If a more concentrated lignin composition is wanted the organic solvent may be removed by evaporation. The extraction may be repeated by adding more organic solvent at least partly not soluble in water to the acidified lignin solution and mix the obtained mixture and leave it to phase separate. By repeating the extraction process the amount of lignin extracted increases, see FIGS. 6 and 7. When extracting an additional time the organic solvent added may be the same or a different solvent as added the first time. By using a different solvent hemi cellulose or other non-wanted substances or salts may be removed.

Hemi cellulose may be removed by having a pH of 2 or less and add the organic solvent and extract the lignin through phase separation as described above. After isolation of the extracted lignin composition in the organic solvent said solvent is removed and the extracted lignin is re-dissolved in a cyclic ether solvent for example THF which does not dissolve hemi cellulose which may be then be removed by for example filtration. This is specifically interesting when treating black or red liquor.

Reduction or Functionalization

The following description is applicable to both aspects described above for extracting lignin.

The reduction may be conducted using any known technique or method. In one embodiment the reduction is conducted by adding a transition metal catalyst, and optionally a hydrogen donor, to the first solution or the isolated organic phase and reducing the lignin by heating the first solution or isolated organic phase.

The functionalization of the lignin may be conducted using any known technique or method. The main purpose of the functionalization is to provide an alkyl group on the lignin and the functionalization may be an esterification. In one embodiment the esterification is conducted by adding an esterification reagent or, a fatty acid and an esterification reagent, and optionally a catalyst, and heating the first solution or the isolated organic phase.

The reduction may use a transition metal catalyst which could be based on but is not limited to palladium, ruthenium, nickel, iron, antimony or titanium. In one embodiment the catalyst is based on nickel, such as Raney nickel or nickel on carbon, or is a palladium based catalyst. In one embodiment the catalyst is a solid phase catalyst. By using a solid phase catalyst the catalyst does not have to be removed before separation of the first solution and possible discharging of the second mixture. In one embodiment a catalyst, preferably a transition metal catalyst, may be added to or arranged in the first mixture in order to treat, depolymerize or reduce the lignin and to increase the amount of extracted lignin. Preferably the catalyst in the first mixture is a solid catalyst so that it does not have to be removed from the extracted lignin or from the second mixture.

The hydrogen donor could be hydrogen, an alcohol or formic acid, preferably a C1-C6 alcohol. A non-limiting list of suitable alcohols is methanol (MeOH), ethanol (EtOH), propanol, iso-propanol (i-PrOH), glycerol, glycol, butanol, t-butanol (i-BuOH) or combinations thereof. In one embodiment the hydrogen donor is the solvent.

The reduction may be performed at temperatures from 30° C., preferably 80° C. or higher, or 120° C. or higher, or 150° C. or higher. However the present invention results in reduced lignin even at temperatures of 200° C. or below.

The esterification reagent may be a carboxylic acid, an anhydride, or a carboxylic ester. In one embodiment the esterification reagent is a carboxylic acid or an anhydride. The esterification agents preferably contain an unsaturated bond. Non-limiting examples of carboxylic acids are fatty acids or C2-C40 carboxylic esters, preferably C4 to C22. Non-limiting examples of anhydrides are C4 to C42 anhydrides. In one embodiment acetic acid anhydride and a C6-C18 fatty acid is used optionally together with an imidazole.

The fatty acid may be but is not limited to C6-C18 fatty acids, saturated or unsaturated, or a mixtures of C2-C18 fatty acids. The fatty acid may further be methylated or ethylated. The fatty acid may be a vegetable fatty acid such as a tall oil, or olive oil, soybean oil, corn oil, hemp or coconut oil. In one embodiment the lignin is esterified using C6-C18 fatty acids and acetic acids. The catalyst for the esterification may be an imidazole, pyridine, titanium propoxide, Sb₂O₃, TiO(OR)₂ or Ti(OR)₄ where R is any alkyl chain branched or straight, or a metal acetyl acetonate such as titanium acetyl acetonate or iron acetyl acetonate.

The esterification may be performed at room temperature, but may be performed at a temperature between 50° C. and 350° C., such as 50° C. or higher, or 80° C. or higher or 100° C. or higher, or 120° C. or higher, or 150° C. or higher, but not higher than 350° C., or 250° C. or lower, or 200° C. or lower, or 180° C. or lower.

Substituting the hydroxyl groups of the lignin increases the solubility in organic solvents. The inventors found that even at low degree of substitution the lignin becomes soluble in ethyl acetate, methyl THF, cyclopentyl methyl ether and iso-propanol. This is especially pronounced when the ester group is a C6 or longer chain, preferably C14 or longer chain.

The second mixture may be discharged from the first container into a second container (4) which in turn may be connected to tubing (1) providing the feed into the first container. The second mixture may be diluted with a solvent and heated preferably during stirring or shaking. In one embodiment the temperature is 180° C. or less, or 150° C. or less, or 120° C. or less. In another embodiment the temperature is 45° C. or more, or 70° C. or more, or 80° C. or more. In one embodiment the mixture is heated to the boiling point of the solvent or solvent mixture in the first mixture. A catalyst, preferably a transition metal catalyst, may be added to or arranged in the second mixture in the second container in order to treat, depolymerize or reduce the lignin. Preferably the catalyst is a solid catalyst so that it does not have to be removed from the second mixture. By circulating the lignin fractions that are not extracted between the first container and the second container thermal reduction, optionally catalysed, will increase the efficiency of the extraction process, i.e. more lignin will be processed according to step d above.

A general method of the reduction (step d of the method described above) comprises of providing a set of components: a substrate to be cleaved, a hydrogen donor, a transition metal based catalyst and at least one solvent. The hydrogen donor is preferably an alcohol or a combination of alcohols. The components are then mixed to form a mixture. The mixing may be done using any suitable technique for example shaking or stirring. The order of addition of each component is not crucial. The mixture is heated to a temperature of preferably not more than 200° C. and left to react, i.e. to cleave the β-O-4 bond in the substrate, for a suitable period of time. The reduction of the present invention is believed also to reduce the aromatic feature (CH-groups in the rings are reduced to CH₂-groups) of the substrate (lignin) and making the substrate more oil like, besides cleaving β-O-4 bonds. This solves the problem of dissolving the substrate in oils or solvents suitable for the fuel preparation steps for example.

Before isolation of the treated lignin the catalyst may be removed. The isolation may be performed using any suitable technique, for example by the use of a magnet, and the isolated product (the treated lignin) may be washed with a suitable solvent for example water.

This process results in reduction of the lignin providing a material suitable to convert into fuel. The solvent may be returned back into the first container and any volatile formed substances may be removed for example acetone.

The Lignin

The lignin to be treated according to the present invention may be lignin dissolved in any suitable solvent. The lignin may be derived from any natural source such as fruits, vegetables, processing waste, wood chips, chaff, grain, grasses, corn, shells, weeds, aquatic plants or hay. In one embodiment the feed of lignin is black or red liquor. In another embodiment the lignin is ultra-filtrated or membrane filtrated.

Black liquor comprises four main groups of organic substances, around 30-45 weight % ligneous material, 25-35 weight % saccharine acids, about 10 weight % formic and acetic acid, 3-5 weight % extractives, about 1 weight % methanol, and many inorganic elements and sulphur. The exact composition of the liquor varies and depends on the cooking conditions in the production process and the feedstock. Red liquor comprises the ions from the sulfite process (calcium, sodium, magnesium or ammonium), sulfonated lignin, hemicellulose and low molecular resins.

### EXAMPLES

In some of the examples below the following lignin types have been used Lignin type A—Kraft lignin

### Example 1

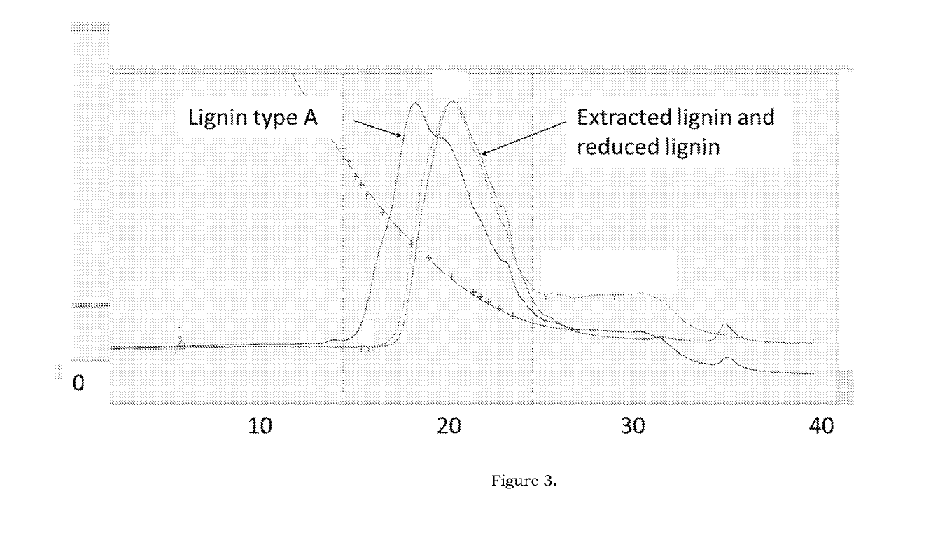

To a 1000 mL 3-neck flask equipped with a mechanical stirrer and a condenser were added 90 g of lignin type A (60% in water) and 600 mL isopropanol. The reaction was heated to reflux and the temperature was kept for additional 5 hours. The mixture was cooled to room temperature and filtrated using a P3 glass filter. A fraction of the solution was evaporated to estimate that the solution contains 22 g product which is used as such in the next reaction. Also a small sample of the product was analysed using HPLC-system (GPC, FIG. 3) and NMR (HSQC).

### Example 2

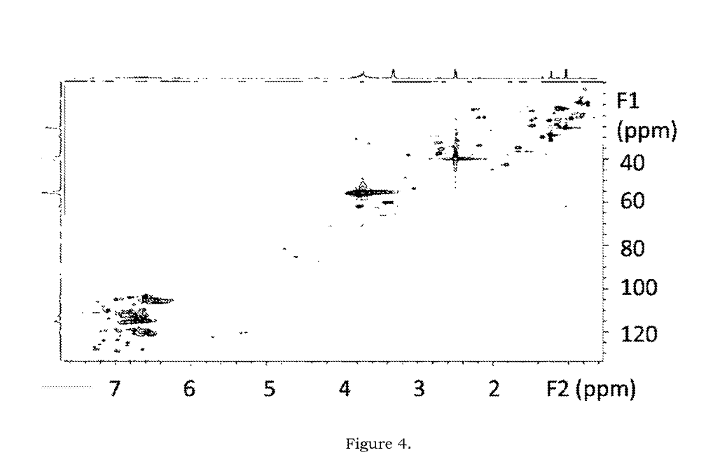

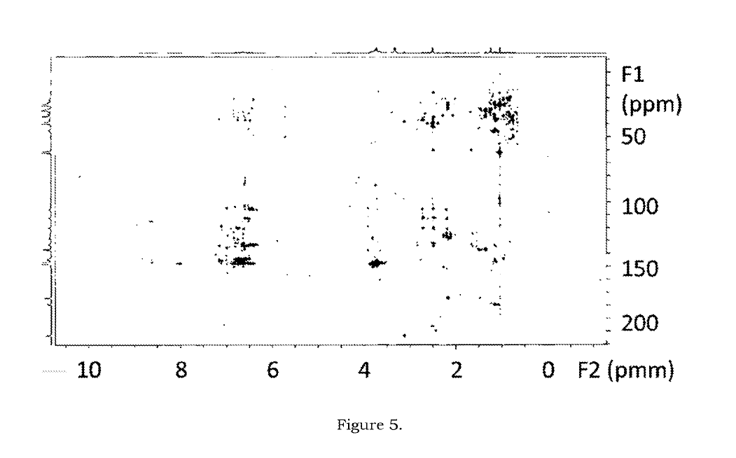

To a 1000 mL 3-neck flask equipped with a mechanical stirrer and a reflux condenser was added the 2-propanol solution of the extracted lignin from example 2. To the solution was added 25 g of wet Raney nickel (58% in water). The mixture was heated to reflux and the temperature was kept for additional 15 hours. The mixture was cooled to room temperature and filtrated using a P3 glass filter. A fraction of the solution was evaporated to estimate that the solution contains 20 g product which is used as such in the next reaction. Also a small sample of the product was analysed using HPLC-system (GPC, FIG. 3) and NMR (HSQC, HMBC FIGS. 4 and 5).

### Example 3

A 400 mL solution of the product (13 g) from above was stirred at 70° C. and a distillation setup was applied. Vacuum was applied and isopropanol was distilled off until about 75 mL remains. RTD (crude tall diesel) (43 g) was added and the temperature was kept for 30 min. The temperature was increased to 130° C. and vacuum was applied and isopropanol was distilled off completely. Imidazole (1.5 mL) and acetic anhydride (23 mL) was added to the reaction mixture. The temperature was increased to 160° C. and vacuum was slowly increased. After 2 hours maximum vacuum of 15 mbar was achieved, and this was kept for 4 hours. Vacuum was released and temperature was lowered to 80° C. LGO (light gas oil) (23 g) was added and a homogeneous solution was obtained.

### Example 4

Liquid-liquid Phase Extraction of Ultrafiltration Lignin

1. An initial solvent screening
1. MeOAc (Methyl acetate)
2. MeOAc/THF (Tetrahydrofuran) (ratio 5:3 and 6:2)
3. EtOAc
4.EtOAc/THF (ratio 5:3 and 4:4)
5. Butanone
6.2-BuOH (sec-butanol)
7. MIBK/THF (ratio 1:1.5) (MIBK is Methyl isobutyl ketone)
8.2-MeTHF (2-Methyltetrahydrofuran)
9. THF

Procedure of solvent screening
1. Add 50 mg LignoBoost (65% dryness) into a round bottom flask
2. Add solvent (2 mL)
3. Stir at room temperature for 10 min
4. Add H2O (0.5 mL) and stir at room temperature for 10 min
5. Observe the phase separation

Result of solvent screening

Good solvents for liquid-liquid phase separations are MeOAc, EtOAc/THF (5:3), 2-Me-THF and THF

2. Effect of the different solvents on liquid-liquid phase extraction of ultrafiltration lignin

General procedure for liquid-liquid phase extraction of ultrafiltration lignin
1. Add 11 g (or 10 mL) of ultrafiltration lignin into round bottom flask
2. Add H₂SO₄ or HCl to adjust pH to 3
3. Stir at room temperature for 5 min
4. Add solvent (80 mL) and stir at room temperature for 30 min
5. Decant, combine and evaporate the organic layer under reduced pressure

Note:

1. In the case when no phase separation occurs the phase separation was induced by adding H₂O (20 mL).

2. 11 g (10 mL) of ultrafiltration lignin comprises about 27% dry solid by weight. Results are shown in FIG. 6.

### Example 5

Liquid-liquid phase extraction of black liquor

Effect of the different solvents on liquid-liquid phase extraction of black liquor

General procedure for liquid-liquid phase extraction of black liquor
1. Add 5 g of black liquor into a round bottom flask
2. Add 20 mL of H₂O
3. Stir at room temperature for 10 min
4. Add H₂SO₄ or HCl to adjust pH to 3
5. Stir at room temperature for 5 min 6. Add solvent (50 mL) and stir at room temperature for 20 min

Repeat the steps in order to increase the yield.

Decant the organic solvent, optionally combine and evaporate the organic layer under reduced pressure

Results are shown in FIG. 7.

Note:

1. Using only THF, no or only little phase separation occurs.

2. In case of EtOAc (or MeOAc), 20 mL of THF was added and mixed together with H₂O.

3. 5 g of black liquor comprises about 50% dry solid by weight and 26% of lignin.

4. It is a fast and easy separation by using EtOAc-THF as the solvents.

5. Liquid-liquid phase extraction of black liquor is easier and more rapid separation than ultrafiltration lignin.

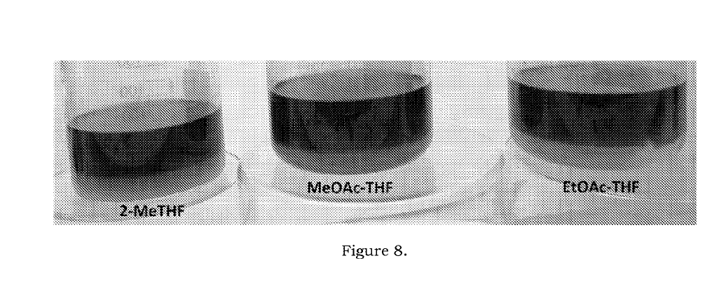

FIG. 8 discloses phase separation.

1.-13. (canceled)

14. A method of transferring lignin into an organic solvent comprising:
a. Providing an aqueous composition of lignin in a container;
b. Lowering the pH of the aqueous composition to a pH of 3 or less and mixing the composition;
c. Adding an organic solvent at least partly not soluble in water to the container forming a first mixture of lignin and organic solvent and mixing the first mixture;
d. Letting the first mixture phase separate into an organic solvent phase and an aqueous phase; and
e. Isolating the organic solvent phase from the first mixture.

15. The method according to claim 14 wherein the solvent is a cyclic ether.

16. The method according to claim 14 wherein the pH is lowered using hydrochloric acid or sulphuric acid.

17. The method according to claim 14 wherein the solvent is a mixture of methyl acetate and THF (tetrahydrofuran) or substituted THF, or a mixture of ethyl acetate and THF or substituted THF, or a mixture of MIBK (methyl isobutyl ketone) and THF or substituted THF.

18. The method according to claim 14 wherein the lignin in the organic solvent phase is treated by reduction using a catalyst based on nickel or a palladium based catalyst.

19. The method according to claim 14 wherein the lignin in the organic solvent phase is treated by functionalization through esterification.

20. The method according to claim 19 wherein the esterification comprises adding an esterification reagent or, a fatty acid and an esterification reagent, and a catalyst to the organic solvent phase and heating the organic solvent phase.

21. The method according to claim 20 wherein the esterification reagent is carboxylic acid or an anhydride.

22. The method according to claim 19 wherein the esterification is done using C6-C18 fatty acids.

23. The method according to claim 18 wherein the treatment is performed at a temperature of 200° C. or below.

24. The method according to claim 14 wherein the aqueous composition of lignin is black liquor.

25. The method according to claim 24 wherein the organic solvent of the isolated organic solvent phase is removed and the lignin is re-dissolved in THF in order to remove hemi cellulose.

26. The method according to claim 14 wherein the solvent is a C1-C10 ester.

27. The method according to claim 26 wherein the solvent is methyl acetate or ethyl acetate.

28. The method according to claim 14 wherein the solvent is a ketone.

29. The method according to claim 28 wherein the solvent is methyl isobutyl ketone (MIBK).
